(19) United States
(12) Patent Application Publication
(10) Pub. No.: US 2023/0144297 A1
(43) Pub. Date: May 11, 2023

(54) TRANSPORTING PARCELS ON TRANSPORTATION LINES

(71) Applicant: HYPERLOOP TECHNOLOGIES, INC., Los Angeles, CA (US)

(72) Inventor: Dapeng ZHANG, West Covina, CA (US)

(73) Assignee: HYPERLOOP TECHNOLOGIES, INC., Los Angeles, CA (US)

(21) Appl. No.: 17/914,535

(22) PCT Filed: Mar. 24, 2021
(86) PCT No.: PCT/US2021/024004

§ 371 Date: Sep. 26, 2022

Related U.S. Application Data
(60) Provisional application No. 63/000,863, filed on Mar. 27, 2020.

(51) Int. Cl. B65G 1/04; B25J 9/16; B25J 9/00; B65G 43/08

(52) U.S. Cl. CPC B65G 1/0485; B25J 9/1687; B25J 9/0093; B65G 43/08; B65G 2201/0285; B65G 2201/0267; B65G 2203/0233

(57) ABSTRACT

In one embodiment, a system is provided. The system includes a set of pallets to hold a set of parcels. The system also includes a conveyor system to move the set of pallets to and from a transportation pod. The system further includes a lift system to lift the set of pallets to different heights within the transportation pod. The system further includes a storage system to store a set of parcels. The system further includes a mechanical arm to move the set of parcels from the storage system to the set of pallets.

### CROSS-REFERENCE TO RELATED APPLICATIONS

This application claims the benefit of U.S. Provisional Patent Application No. 63/000,863, filed on Mar. 27, 2020. The disclosure of the above-referenced application is hereby incorporated by reference in its entirety.

### TECHNICAL FIELD

Aspects of the present disclosure relate to a transportation system, and more particularly, to transporting parcels on transportation lines.

### BACKGROUND

Transportation systems may include multiple transportation lines and multiple transportation pods that travel along the various transportation lines. The transportation lines may be directed or directional routes that allow transportation pods (e.g., vehicles) to travel between different locations in the transportation system. For example, a transportation line may be similar to links, tracks, or rails that allow transportation pods to travel to different locations (e.g., stops, stations, etc.) within the transportation system. The transportation pods may be capsules, vehicles, cars, or some other type of device that may move from one location to another. For example, the transportation pods may be similar to trains, although the transportation pods may not travel on tracks. The transportation pods may transport various things between the stops in the transportation system. For example, the transportation pods may transport (e.g., move, convey, etc.) passengers or items, such as parcels, packets, objects, products, goods, freight, merchandise, payloads, shipments, packets, etc., between different stops in the transportation system.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example transportation system, in accordance with one embodiment of the present disclosure.

FIG. 2 is a block diagram that illustrates an example transportation system, in accordance with one embodiment of the present disclosure.

FIG. 3 is a block diagram that illustrates an example destination, in accordance with one embodiment of the present disclosure.

FIG. 4 is a block diagram that illustrates an example payload system, in accordance with one embodiment of the present disclosure.

FIG. 5 is a flow diagram of a process of transporting parcels in a transportation system, in accordance with one embodiment of the present disclosure.

FIG. 6 is a block diagram of an example computing device that may perform one or more of the operations described herein, in accordance with one embodiment of the present disclosure.

### DETAILED DESCRIPTION

As discussed above, transportation systems may include multiple transportation lines and multiple transportation pods that travel along the various transportation lines. The transportation pods may be capsules, vehicles, cars, or some other type of device that may move from one location to another. The transportation pods may transport various things between the stops in the transportation system. For example, the transportation pods may transport (e.g., move, convey, etc.) passengers or items, such as products, goods, freight, merchandise, payloads, shipments, packets, etc., between different stops in the transportation system. The transportation lines may be connected via junctions that allow transportation pods to merge from one transportation line to another.

Delivering parcels (e.g., packages, boxes, bags, containers, etc.) in an urban area poses various issues such as long and unreliable delivery time, lack of delivery personnel, and high cost for transporting and handling the parcels. Many of these issues are associated with or caused by traffic problems such as road congestion, emission of pollutants (e.g., carbon dioxide), and excess use of parking spaces. As e-commerce continues to grow and develop, these issues will worsen and become more challenging.

Traditional track or rail based transportation systems (e.g., rail roads, trains, etc.) are generally not suitable for delivering parcels in an urban area or environment. One challenge for urban rail delivery (e.g., for delivering parcels in an urban environment) is that these deliveries generally require smaller train sizes, operating at higher speeds, and operating at higher frequencies in terms of the number of departures. Traditional rail technology (e.g., traditional track or rail based transportation systems) are unable to address these challenges.

In one embodiment, a magnetic levitation (maglev) transportation system (e.g., a hyperloop) may be used to transport parcels in an urban environment or area. The magnetic levitation transportation system may use one or more magnetic levitation (maglev) pods or capsules that travel along magnetic tracks located within a tube (e.g., a vacuum sealed or low air pressure tube). The magnetic levitation transportation system may allow smaller vehicles (e.g., pads or capsules) to operate a higher speeds and a higher frequency. Thus, the magnetic levitation transportation system may be well suited for the delivery of parcels in an urban environment. The use of a magnetic levitation transportation system may also reduce traffic in the dense urban area or environments (e.g., may reduce the number of delivery trucks or vehicles travelling along roads).

In one embodiment, the magnetic levitation transportation system may include a fully autonomous payload system. The payload system would allow parcels to be delivered to between different stations or stops without manual handling of the parcel by personnel (e.g., mailmen, delivery men, etc.). A parcel may be automatically loaded onto a pod or capsule by a first payload system at a warehouse or other storage facility. The pod or capsule may deliver the parcel to receivers at stations or stops without human intervention. A second payload system at a receiving stop or station may unload, remove, etc., the parcels from the pod or capsule. The payload system includes a conveyor mechanism (e.g., a conveyor belt), a pallet for stacking or arranging parcels, a lift mechanism, a mechanical arm (e.g., a robotic arm), and a storage system to store parcels at stations/stops.

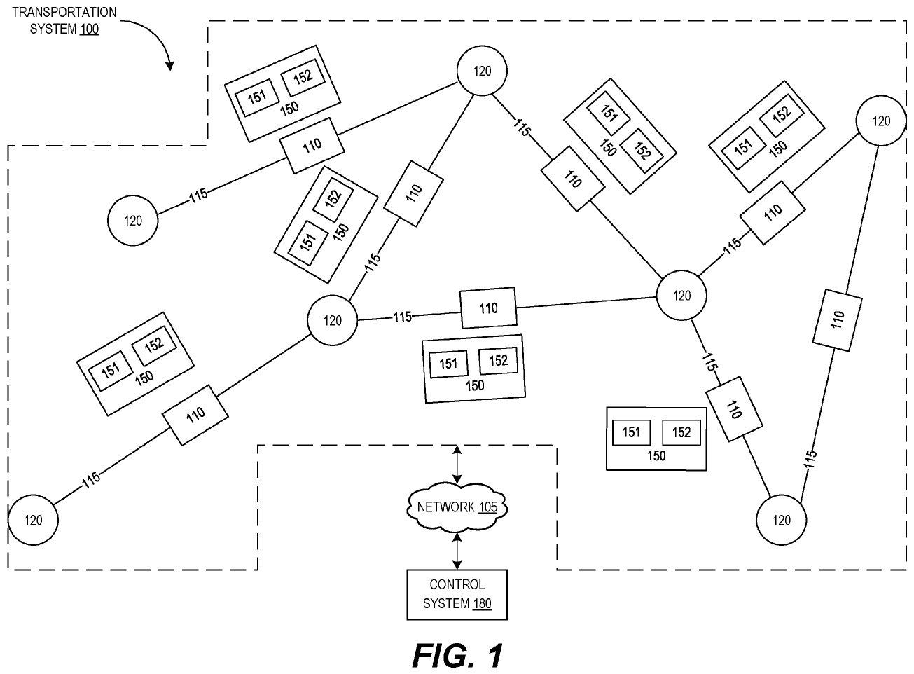

FIG. 1 is a block diagram that illustrates an example transportation system 100, in accordance with one embodiment of the present disclosure. The transportation system 100 includes transportation pods 110, transportation lines 115, and destinations 120. As discussed above, the transportation lines 115 may be directed or directional paths that allow transportation pods 110 (e.g., vehicles) to travel between the different destinations 120. For example, the transportation lines 115 may be similar to links, tracks, or rails that allow transportation pods 110 to travel to different locations (e.g., destinations 120) within the transportation system 110. In one embodiment, the transportation lines 115 may be tubes within which the transportation pods 110 may travel. For example, the transportation lines 115 may be vacuum sealed (or near vacuum sealed) tubes that include magnetic (e.g., electromagnetic) tracks. Different transportation lines 115 may be connected to each other via junctions between the transportation lines. A junction may be a location where two transportation lines converge or diverge. For example, a junction may allow a transportation pod 110 on a first transportation line to merge onto a second transportation line.

The transportation pods 110 may each be capsules, vehicles, cars, or some other type of device that may move from one location to another. For example, the transportation pods 110 may be similar to trains, although the transportation pods 110 may not travel on tracks. In one embodiment, transportation pods 110 may be a magnetic levitation (maglev) pod or capsule that travels along magnetic tracks located within a tube (e.g., a vacuum sealed or low air pressure tube). The transportation pods 110 may transport various things between the stops in the transportation system 100. For example, the transportation pods 110 may transport (e.g., move, convey, etc.) passengers between different stops in the transportation system 100. In another example, the transportation pods 110 may transport items, such as products, goods, freight, merchandise, payloads, shipments, packets, etc., between different stops in the transportation system. The transportation pods 110 may include multiple portions (e.g., multiple pods that are logically grouped or physically coupled together). The length of each of the transportation pods 110 may vary based on the needs or requirements of the transportation system 100 (e.g., may vary from less than ten meters to hundreds of meters). Transportation pods 110 may each include one or more of a light detection and ranging (LiDAR) device, a laser range finder, a camera (e.g., a video camera), a radio frequency device (e.g., a radar device), an ultrasonic sensor, etc, and/or other device that may be used for autonomous navigation and/or operation of the transportation pods 110.

The destinations 120 may be stops, stations, waypoints, etc., where passengers and/or cargo may be loaded onto the transportation pods 110. For example, the destinations 120 may be different cities, towns, metropolitan areas, etc., that are interconnected by the transportation lines 115. Although the present disclosure may refer to cities, towns, and/or metropolitan areas, the destinations 120 may be any location where a transportation 110 may stop (e.g., temporarily stop to load/unload passengers and/or cargo). For example, the destinations 120 may be stops (e.g., stations) within one city (e.g., one stop every few city blocks).

The infrastructure nodes 150 may be devices, systems, mechanisms, etc., that allow the transportation system 100 to detect, communicate with, and manage the transportation pods 110. The infrastructure nodes 150 may be positioned at various locations along the transportation lines 115. For example, there may be an infrastructure node 150 located every 10 meters, 50 meters, 100 meters, or some other appropriate distance along each of the transportation lines 115. The infrastructure nodes 150 may be placed at known or predetermined locations along the transportation lines 115 (e.g., the geographical locations of the infrastructure nodes 150 are known).

An infrastructure node 150 includes a sensor node 151. The sensor node 151 may include various devices, systems, mechanisms, etc., that allow the infrastructure node 150 to detect the location and/or speed of the transportation pods 110 as they travel through the transportation lines 115. For example, the sensor node 151 may include one or more of a radio frequency device (e.g., a radar system), a laser range finder, a camera (e.g., a video camera), an ultrasonic sensor, a Hall effect sensor, a presence sensor/detector (e.g., a device to detect the presence of a transportation pod 110), etc., that may be used to detect the speed of the transportation pods 110. Because the location of an infrastructure node 150 is known, the sensor node 151 allows an infrastructure node 150 to determine one or more of the speed and acceleration of a transportation pod at a certain point or location along a transportation line. The sensor node 151 may also be able to identify a transportation pod. For example, the sensor node 151 may include a radio-frequency identification (RFID) reader which may read an RFID tag located on a transportation pod. In another example, the sensor node 151 may determine an identifier for a transportation pod based on communications (e.g., messages) exchanged with the transportation pod via communication node 152.

An infrastructure node 150 also includes a communication node 152. The communication node 152 may allow the infrastructure node to communicate with one or more of a control system (e.g., a main control system, a command and control center, etc.), transportation pods 110, and other infrastructure nodes 150. For example, the communication node 152 may include a network interface (e.g., a wired network interface, a wireless network interface, etc.) that allows the infrastructure node 150 to communicate data (e.g., transmit and receive messages, packets, frames, etc.). Various communication protocols and technologies (e.g., cellular communications systems, Wi-Fi, Bluetooth, etc.) may be used by the communication node 152 to communicate data. The communication node 152 may communicate data about a transportation pod detected by a sensor node 151. For example, the transportation pod 110 passes an infrastructure node 150, the sensor node 151 may determine an identifier for the transportation pod 110 (e.g., a name, a serial number, a car number, etc.) and may determine the speed or acceleration of the transportation pod 110. The speed or acceleration of the transportation pod 110 may be referred to as movement information. The communication node 152 may transmit the movement information to other infrastructure nodes 150 or a control system, as discussed in more detail below.

The transportation system 100 also includes a control system 180. The control system 180 may control, manage, and monitor the operation of the transportation pod 110, as discussed in more detail below. The transportation system 100 may further include infrastructure nodes 150, as discussed in more detail below. Each infrastructure node 150 may include a sensor node 151 and a communication node 152. In one embodiment, the transportation system 100 may be a closed transportation system where the addition and removal of transportation pods within the transportation system 100 is controlled (e.g., controlled or managed by the control system 180).

The control system 180 and the infrastructure nodes 150 may be interconnected or coupled to each other (e.g., communicatively coupled) via a network 105. The network 105 may carry communications (e.g., data, message, packets, frames, other appropriate types or formats of data, etc.) between the infrastructure nodes and the control system 180. The network 105 may be a public network (e.g., the Internet), a private network (e.g., a local area network (LAN) or wide area network (WAN)), or a combination thereof. In one embodiment, the network 105 may include a wired or a wireless infrastructure, which may be provided by one or more wireless communications systems, such as a wireless fidelity (Wi-Fi) hotspot connected with the network and/or a wireless carrier system that can be implemented using various data processing equipment, communication towers (e.g. cell towers), etc. The transportation pods 110 may also be connected to each other, the infrastructure nodes 150, and the control system 180 via the network 105.

Each transportation pod 110 may include a pod control module (not illustrated in FIG. 1). In one embodiment, the pod control module may control the operation of a transportation pod 110. For example, the pod control module may increase or decrease the speed of the transportation pod 110, may cause a transportation pod 110 to stop at a station (e.g., a destination 120), etc. In another example, the pod control module may cause a transportation pod 110 to merge from one transportation line 115 to another transportation line 115 at a junction between the two transportation lines 115.

The pod control module of a transportation pod 110 may communicate with other transportation pods 110 (e.g., other pod control modules). For example, the pod control module may transmit the current speed and location of a transportation pod 110 to another transportation pod 110. This may be referred to as vehicle-vehicle (V-V) communications. The pod control module may also communicate with the infrastructure nodes 150. For example, the pod control module may transmit the current speed and location of the transportation pod 110 to the in structure nodes 150. This may be referred to as vehicle-infrastructure (V-I) communications. The pod control module may also transmit and/or receive messages or other data with other transportation pods 110 via the infrastructure nodes 150 (e.g., the messages/data may be forwarded by the infrastructure nodes 150). This may be referred to as vehicle-infrastructure-vehicle (V-I-V) communications.

In some embodiments, the pod control module of a transportation pod 110 may operate in conjunction and/or coordination with the control system 180 to control the operation of the transportation pod 110. For example, the control system 180 may communicate with the pod control module of a transportation pod 110 and inform the pod control module of other transportation pods 110 in the vicinity of a junction. The pod control module may increase/decrease the speed of the transportation pod to allow the transportation pod to merge safely via the junction.

In other embodiments, the control system 180 may control the operation of the transportation pods 110. For example, the control system 180 may determine when a transportation pod 110 should increase/decrease speed, should merge from one transportation line 115 to another transportation line 115, etc. The control system 180 may transmit messages or instructions to the control modules of the transportation pods 110 to cause the transportation pods to increase speed, decrease speed, merge, etc.

Each of the pod control modules and the control system 180 may include one or more computing devices. A computing device may include hardware such as processing devices (e.g., processors, central processing units (CPUs), memory (e.g., random access memory (RAM), storage devices (e.g., hard-disk drive (HDD), solid-state drive (SSD), etc.), and other hardware devices (e.g., sound card, video card, etc.). A computing device may include any suitable type of device or machine that has a programmable processor including, for example, server computers, desktop computers, laptop computers, tablet computers, smartphones, etc. In some examples, a computing device may include a single machine or may include multiple interconnected machines (e.g., multiple servers configured in a cluster).

In one embodiment, the pod control modules and the control system 180 may also include one or more virtual machines (VMs). A VM may be a software implementation of a machine (e.g., a software implementation of a computing device) that includes its own operating system (referred to as a guest OS) and executes application programs, applications, software. A VM may execute on a hypervisor which executes on top of the OS for a computing device (referred to as a host OS). The hypervisor may also be referred to as a virtual machine monitor (VMM). The hypervisor may manage system resources, including access to hardware devices such as physical processing devices (e.g., processors, CPUs, etc.), physical memory (e.g., RAM), storage device (e.g., HDDs, SSDs), and/or other devices (e.g., sound cards, video cards, etc.). The hypervisor may also emulate the hardware (or other physical resources) which may be used by the VMs to execute software/applications.

In one embodiment, the pod control modules and the control system 180 may also include one or more containers. A container may be an isolated set of resources allocated to executing an application, software, and/or process independent from other applications, software, and/or processes. A container may execute on a container engine which executes on top of the OS for a computing device. The host OS (e.g., an OS of the computing device) may use namespaces to isolate the resources of the containers from each other. The container may share the kernel, libraries, and binaries of the host OS with other containers that are executing on the computing device. The container engine may allow different containers to share the host OS (e.g., the OS kernel, binaries, libraries, etc.) of a computing device. The container engine may also facilitate interactions between the container and the resources of the computing device.

As discussed above, track or rail based transportation systems are generally not suitable for delivering or transporting parcels in an urban area or environment. For example, a track or rail based transportation system may be less suitable for local or shorter distance delivers (e.g., deliveries within a city). Lack of automation when loading or unloading parcels may also be problematic when delivering and/or transporting parcels.

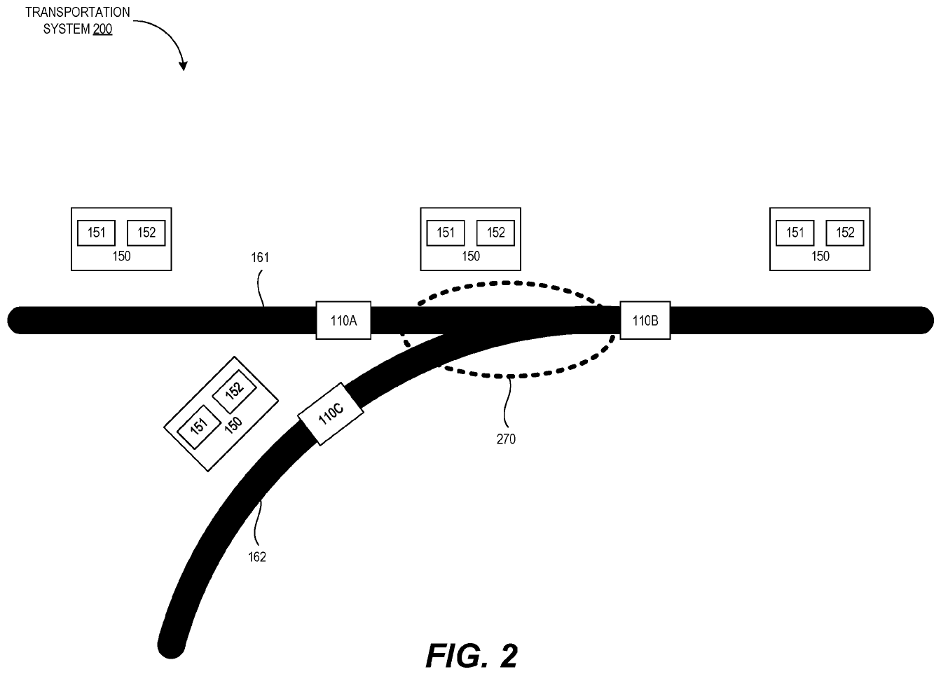

FIG. 2 is a block diagram that illustrates an example transportation system 200, in accordance with one embodiment of the present disclosure. The transportation system 200 includes a transportation line 161 and a transportation line 162. The transportation system 200 also includes infrastructure nodes 150. Each infrastructure node 150 may include a sensor node 151 and a communication node 152. The transportation system 200 further includes transportation pod 110A, transportation pod 110B, and transportation pod 110C. In one embodiment, the transportation system 200 may be a closed transportation system where the addition and removal of transportation pods within the transportation system 200 is controlled. For example, a control system (not illustrated in FIG. 1) may control the addition and removal of transportation pods within the transportation system 200.

The transportation line 161 and the transportation line 162 may each be directed or directional routes that allow transportation pods 110A, 110B, and 110C to travel between different locations in the transportation system. For example, the transportation line 161 and the transportation line 162 may be similar to links, tracks, or rails that allow transportation pods 110A, 110B, and 110C to travel to different locations (e.g., stops, stations, etc.) within the transportation system. The transportations lines 161 and 162 may be a subset of the transportation lines within the transportation system 200. For example, the transportation system 200 may include tens, hundreds, thousands, or some other appropriate number of transportation lines in other embodiments. In one embodiment, the transportation lines 161 and 162 may be tubes within which the transportation pods 110A, 110B, and 110C may travel. For example, the transportation lines 161 and 162 may be vacuum sealed (or near vacuum sealed) tubes that include magnetic (e.g., electromagnetic) tracks.

As discussed above, the transportation pods 110A, 110B and 110C may each be capsules, vehicles, cars, or some other type of device that may move from one location to another. In one embodiment, transportation pods 110A, 110B, and 110C may be a magnetic levitation (maglev) pod or capsule that travels along magnetic tracks located within a tube (e.g., a vacuum sealed or low air pressure tube). The transportation pods 110A, 110B, and 110C may transport various things between the stops in the transportation system 200. The transportation pods 110A, 110B, and 110C may include multiple portions (e.g., multiple pods that are logically grouped or physically coupled together). The length of each of the transportation pods 110A, 110B, and 110C vary in different embodiments. Also as discussed above, the infrastructure nodes 150 may be devices, systems, mechanisms, etc., that allow the transportation system 200 to detect, communicate with, and manage the transportation pods 110A, 110B, and 110C. The infrastructure nodes 150 may be positioned at various locations along the transportation lines 161 and 162.

The transportation system 200 also includes a junction 270. A junction may be a location where two transportation lines converge or diverge. For example, junction 270 may be a location where the transportation line 162 converges or merges with transportation line 161. As illustrated in FIG. 1, transportation pod 110C may be merging onto transportation line 161 from transportation line 162 via the junction 270. The junction 270 (and other junctions in the transportation system 200) may allow for cross-line operation in the transportation system 200.

Cross-line operation allows a transportation pod move across or use multiple transportation lines. Cross-line operation may provide various benefits to the transportation system 200. For example, it may reduce the number of transfers that a passenger or cargo makes when traveling to a destination. Rather than stopping at a station or stop on a first transportation line and moving to a different transportation pod on another transportation line, it would be quicker and more efficient to allow the same transportation pod to merge from the first transportation line to the second transportation line (e.g., to cross transportation lines). Cross-line operation may also allow line based (e.g., track or tubed based) transportation systems to become a more preferred mode of transportation or deliver of parcels (e.g., cargo, packages, bags, containers, etc.). This may divert passengers and cargo from congested roads to public transportation.

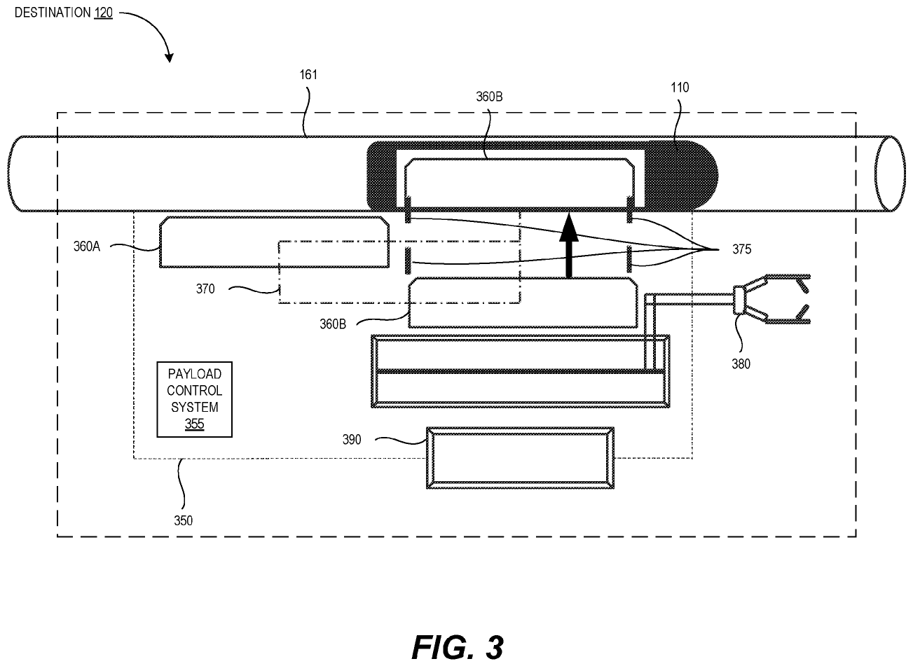

FIG. 3 is a block diagram that illustrates an example destination 120, in accordance with one embodiment of the present disclosure. In one embodiment, the destination 120 may a destination (e.g., a station, a stop, etc.) in a closed transportation system where the addition and removal of transportation pods within the transportation system is controlled. For example, a control system (not illustrated in FIG. 3) may control the addition and removal of transportation pods within the transportation system. The destination 120 includes a transportation line 161 (e.g., a tube). For example, at least a portion of the transportation line 161 may run or go through the destination 120. A transportation pod 110 may stop at the destination 120. For example, the transportation pod 110 may temporarily stop or pause at the destination 120 to allow for loading and/or unlading of parcels, as discussed in more detail below. The destination 120 further includes a payload system 350. The payload system 350 may allow parcels (e.g., packages, bags, boxes, containers, etc.) to be loaded or unloaded (e.g., automatically loaded/unloaded) from the transportation pod 110. The payload system 350 includes pallets 360A and 360B, a conveyor system 370, a lift system 375, a mechanical arm 380, a storage system 390, and a payload control system 355.

As discussed above, track or rail based transportation systems are generally not suitable for delivering or transporting parcels in an urban area or environment. For example, a long train size, lower speed, and lower frequency (e.g., fewer numbers of trains passing through a station or top) are generally not suitable for delivering or transporting parcels in an urban area or environment. In addition, track or rail based systems may have fewer destinations within an area. For example, a track or rail based system may not have multiple stops within a few city blocks. Furthermore, the lack of automation when loading or unloading parcels at stations may also result in a more time consuming, more labor intensive, or more inefficient process for delivering parcels.

The embodiments, examples, implementations, etc., disclosed herein may address the above-noted and other deficiencies by using a magnetic levitation transportation system (e.g., a maglev system, a hyperloop) and an automated payload system (e.g., payload system 350). The automated payload system allows parcel delivery to be integrated into the destination 120 which may also be used for transporting passengers. Although the present disclosure may refer to a magnetic levitation transportation system, the embodiments, examples, and/or implementations described herein may be used with other types of transportation systems. For example, the may be applied to a rail based transportation system such as trollies, light rail, a metropolitan subway system, etc.

In one embodiment, the payload control system 355 may determine and/or detect that transportation pod 110 has arrived at the destination 120. For example, the payload control system 355 may be coupled to sensors (e.g., laser sensors, motion sensors, radar, etc.) that may detect the transportation pod 110. In another example, the payload control system 355 may be coupled to a control system for a transportation system (e.g., control system 180) and the control system for the transportation system may communicate with the payload control system 355 to indicate that the transportation pod 110 has arrived at the destination 120.

In one embodiment, the payload control system 355 may determine whether the transportation pod 110 includes one or more parcels that are to be delivered at the destination 120. For example, the payload control system 355 may access a database, an inventory system, etc., that may indicate that the transportation pod 110 includes one or more parcels that are to be delivered at the destination 120. In another example, the control system for the transportation system may communicate with the payload control system 355 to indicate that the transportation pod 110 includes one or more parcels that are to be delivered at the destination 120. The one or more parcels may be located on pallet 360B.

In one embodiment, each of the pallets 360A and 360B may be a platform, surface, a tray, etc., that is sized to fit within the transportation pod 110. For example, the length and width of each of the pallets 360A and 360B may allow the pallets 360A and 360B to be inserted into the transportation pod 110 (e.g., to fit through a door or opening of the transportation pod 110, to fit within an internal space or compartment of the transportation pod 110, etc.). A transportation pod 110 may be able to store multiple pallets at different heights within the transportation pod 110. For example, the pallets 360A and 360B (and other pallets) may be arranged within the transportation pod 110 similar to shelves on a stand. Each of the pallets 360A and 360B may include dividers, that allow the pallets 360A and 360B to be divided into different size or shape compartments. The payload system 350 may include various numbers of pallets in different embodiments.

In one embodiment, conveyor system 370 (illustrated by the dotted and dashed lines) may move the pallets 360A and 360B to different locations within the payload system 350. For example, the conveyor system 370 may include one or more conveyor belts (which may be interconnected) that move the pallets 360A and 360B closer between the transportation pod 110, and the mechanical arm 380. The conveyor system 370 may be located proximate to the lift system 375 and/or the mechanical arm 380. This allows the conveyor system 370 to move pallets to the lift system 375 so that the pallets can be loaded into or unloaded from the transportation pod 110. This also allows a pallet to be moved closer to the mechanical arm 380 so that the mechanical arm can load parcels onto a pallet.

In one embodiment, the lift system 375 may lift, elevate, move, etc. the pallets 360A and 360B to different heights. For example, the lift system 375 may include an elevator. This may allow the pallets 360A and 360B (and other pallets) to be loaded or inserted into the transportation pod 110 at different heights. For example, the conveyor system 370 may be at a first height. The lift system 375 may lift a pallet to a height that is higher or lower than the first height. The lift system 375 and/or portions of the lift system 375 may be located in transportation pod 110 in some embodiments. The pallets in the transportation pod 110 may be positioned above each other to allow more pallets to be loaded into the transportation pod 110. The payload control system 355 may indicate to the lift system 370 the height or level at which a pallet should be loaded into the transportation pod 110. For example, the payload control system 355 may indicate to the lift system 370 that a particular level or height within the transportation pod is empty and that the lift system 370 should lift the pallet 360B to that height and insert or load the pallet 360 into the transportation pod 110 (as illustrated by the arrow in FIG. 3). The payload control system 355 may also indicate to the lift system 370 the height or level from which a pallet should be removed or unloaded from the transportation pod 110. The transportation pod 110 may include rollers, rails, slots, locking mechanisms, etc., to secure the pallets 360A and 360B within the transportation pod 110.

In one embodiment, the mechanical arm 380 may load parcels onto the pallets 360A and 360B, and may unload parcels from the pallets 360A and 360B. For example, the lift system 375 and the conveyor system 370 may move the pallet 360A from the transportation pod towards the mechanical arm (e.g., in a counter-clockwise direction on the conveyor system 370). The mechanical arm 380 may obtain (e.g., pick up, grab, etc.) parcels from the storage system 390 and place them on the pallet 360B. After the pallet 360B is loaded (with parcels), the conveyor system 370 may move the pallet onto the lift system 375 (as illustrated by the arrow). The lift system may load the pallet 360B into the transportation pod 110, as discussed above. The conveyor system 370 may also move the pallet 360A closer to the mechanical arm 380. The mechanical arm 380 may remove the parcels from the pallet 360 and place them in the storage system 390.

In one embodiment, the mechanical arm 380 may include various sensors, camera, scanners, etc. For example, ultrasonic sensors, radar sensors, LIDAR sensors, cameras, etc., may be used to detect the locations, positions, orientations, etc., of parcels on the pallets 360A and 360B. The mechanical arm 380 may also include a scanner (e.g., a reader, a barcode scanner, a camera, etc.). The scanner may read or scan identifiers, such as barcodes, on the parcels, the pallets 360A and 360B, and the storage system 390. The scanner may also read other identifiers (e.g., text, a tracking number, a recipient's name, an address, etc.). This may allow the mechanical arm 380 to identify which parcels should be moved between the storage system 390 and the pallets 360A and 360B. The identifier that is detected, determined, obtained, etc., by the mechanical arm 380 may be used to determine a compartment within the storage system 390. For example, different parcels may be placed into different compartments based on various factors such as the number of available compartments (e.g., empty compartments), the dimensions of the parcel, the dimensions of the compartment, etc.

The mechanical arm 380 also includes a gripping component (e.g., a gripper, a grabber, a hand, a claw, etc.) that may be used to grab, hold, etc., a parcel. The gripping component may be adjustable to hold or grab parcels of various sizes. The head of the mechanical arm 380 (e.g., the gripping component) may have a wide range of motion. For example, the arm and head of the mechanical arm may each have a 360 degree of rotation about various axes. In addition, the arm and head of the mechanical arm 380 may be able to move along various axes. For example, the arm and/or head of the mechanical arm may be able to move from left to right, up and down, etc. The mechanical arm 380 may move (e.g., may grab) parcels from the pallet 360B and may place the parcels into different compartments in the storage system 390.

In one embodiment, the payload control system 355 may be one or more computing devices (e.g., a server computer, a laptop computer, etc.) that may manage, track, etc., the parcels that are loaded or unloaded by the payload system 350. For example, the payload control system 355 may track the barcodes or identifiers of parcels that are stored in the storage system 390. The payload control system 355 may also track the barcodes or identifiers of the parcels that are removed from the transportation pod 110. The payload control system 355 may be coupled to a network (e.g., a wireless network, a cellular network, the Internet, etc.) to allow the payload control system 355 to communicate with other services and computing devices (e.g., to communicate with a database of a deliver service).

In one embodiment, the storage system 390 may be a container, locker, etc., that is used to store parcels that are to be loaded onto the transportation pod 110 and have been unloaded from the transportation pod 110. The storage system 390 may include multiple doors or openings to allow parcels to be placed inside the storage system 390 by the mechanical arm 380 or users (e.g., people who pick up or drop off parcels at the storage system 390). The multiple doors or openings may provide access to compartments within the storage system 390 where parcels may be stored. The storage system 390 may include an interface (e.g., a panel, a keypad, a touch screen, etc.) that allows users to deposit and retrieve parcels from the storage system 390. For example, a user may have a code that may open a particular door to allow a user to place a parcel in a compartment or remove the parcel from a compartment.

A first side (e.g., a back side) of the storage system 390 may be accessible to the mechanical arm 380 to allow the mechanical arm 380 to place parcels in a compartment or remove parcels from the compartment. The first side may not have doors to allow the mechanical arm 380 to place parcels within the compartments. A second side (e.g., a front side) of the storage system 390 may include doors or openings that allow the users to access a compartment in the storage system 390. The payload control system 355 may generate and transmit messages to the users (e.g., to a computing device of the user, to a tablet, to a smartphone, etc.) when different parcels are loaded into the compartments. This may notify a user that a parcel is ready for pick up at the storage system 390. The message may include a code, authentication credentials, etc., that the user may use to access the compartment in the storage system 390. The message may also include an identifier for the compartment where the parcel is located, a location of the storage system (e.g., a street address, GPS coordinates, a name of the station, etc.), and a time when the parcel was placed in the compartment.

In one embodiment, the payload control system 355 may receive a request to retrieve a parcel from a compartment within the storage system. For example, a user may indicate the compartment (e.g., may select the compartment, may provide an identifier for the compartment, etc.). The user may also provide one or more credentials to access the compartment (e.g., an access code, a code, a password, etc.). The payload control system 355 and/or storage system 390 may authenticate the request retrieve the parcel. For example, the payload control system 355 may authenticate the request and/or use based on the one or more credentials. If the one or more credentials are valid (for the compartment), the payload control system 355 and/or storage system 390 may allow access to the compartment to allow retrieval of the parcel from the compartment. For example, the payload control system 355 and/or storage system 390 may open a door for the compartment.

In one embodiment, the storage system 390 may also allow users to drop off one or more parcels for delivery. For example, the payload control system 355 may receive a request from a user to deposit a parcel into a compartment of the storage system 390. The user may use a code or message to open a compartment of the storage system 390 and deposit (e.g., drop off) a parcel for delivery to another station or stop. The user may indicate a destination and/or recipient for the parcel. After the parcel is deposited by the user, the payload control system 355 may determine whether the parcel (that was deposited by the user) should be placed in the transportation pod 110. For example, the payload control system 355 may determine whether the transportation pod 110 will stop at the destination indicated by the user. If the transportation pod 110 will stop at the destination indicated at the user, the payload control system 355 may determine that the transportation pod 110 can be used to deliver the parcel to the destination. The payload control system 355 may instruct the mechanical arm 380 to move that parcel from the compartment onto pallet 360A so that the pallet 360A can be loaded onto the transportation pod 110. The pallet 360A may be placed onto the conveyor system 370 to move the pallet 360A to the transportation pod 110. The pallet 360A may be loaded into the transportation pod 110 using the lift system 375 and/or the conveyor system 370.

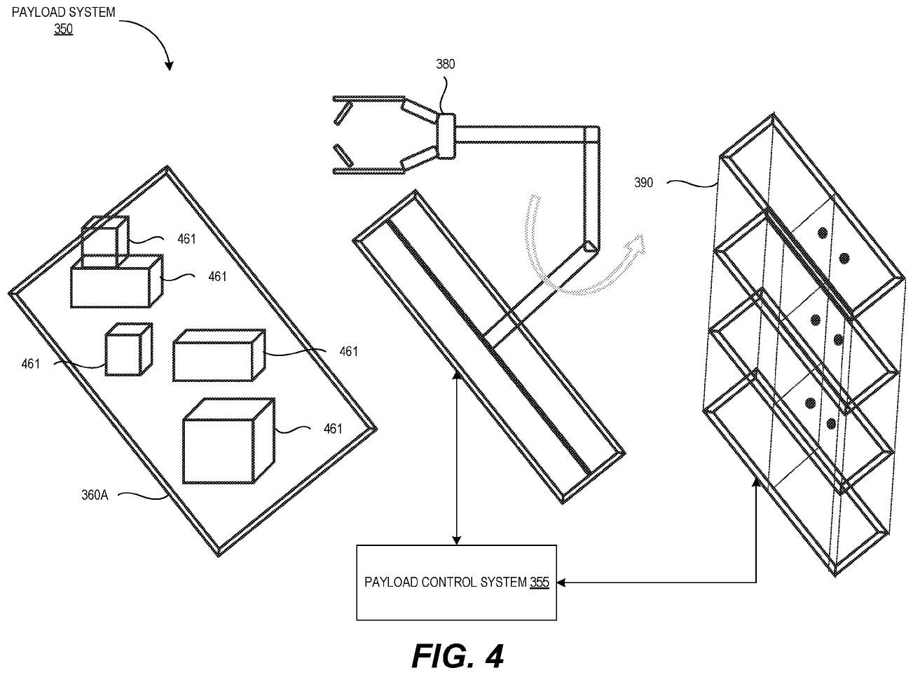

FIG. 4 is a block diagram that illustrates an example payload system 350, in accordance with one embodiment of the present disclosure. The payload system 350 includes a pallet 360A, a mechanical arm 380, a storage system 390, and a payload control system 355. The payload system 350 may also include a conveyor system 370 and a lift system 375, as discussed above.

Pallet 360A may be a platform, surface, a tray, etc., that is sized to fit within a transportation pod. The pallet 360A may hold various parcels 461. A transportation pod may be able to store multiple pallets at different heights within the transportation pod 310. Pallet 360A may include dividers, that allow the pallet 360A to be divided into different size or shape compartments. The payload system 350 may include various numbers of pallets in different embodiments.

The mechanical arm 380 may load parcels onto the pallet 360A and may unload parcels from the pallet 360A, as discussed above. The mechanical arm 380 may include various sensors, camera, scanners, etc. The mechanical arm 380 may also include a scanner (e.g., a reader, a barcode scanner, etc.). The scanner may read or scan barcodes on the parcels, the pallets 360A and 360B, and the storage system 390. The mechanical arm 380 also includes a gripping component (e.g., a gripper, a grabber, a hand, a claw, etc.) that may be used to grab, hold, etc., a parcel.

The storage system 390 may be a container, locker, etc., that is used to store parcels that are to be loaded onto the transportation pod 310 and have been unloaded from the transportation pod 310. The storage system 390 may include multiple doors or openings to allow parcels to be placed inside the storage system 390 by the mechanical arm 380 or users. The multiple doors or openings may provide access to compartments within the storage system 390 where parcels may be stored. The storage system 390 may include an interface that allows users to deposit and retrieve parcels from the storage system 390.

The payload control system 355 may be one or more computing devices (e.g., a server computer, a laptop computer, etc.), virtual machines, containers, etc., that may manage, track, etc., the parcels that are loaded or unloaded by the payload system 350.

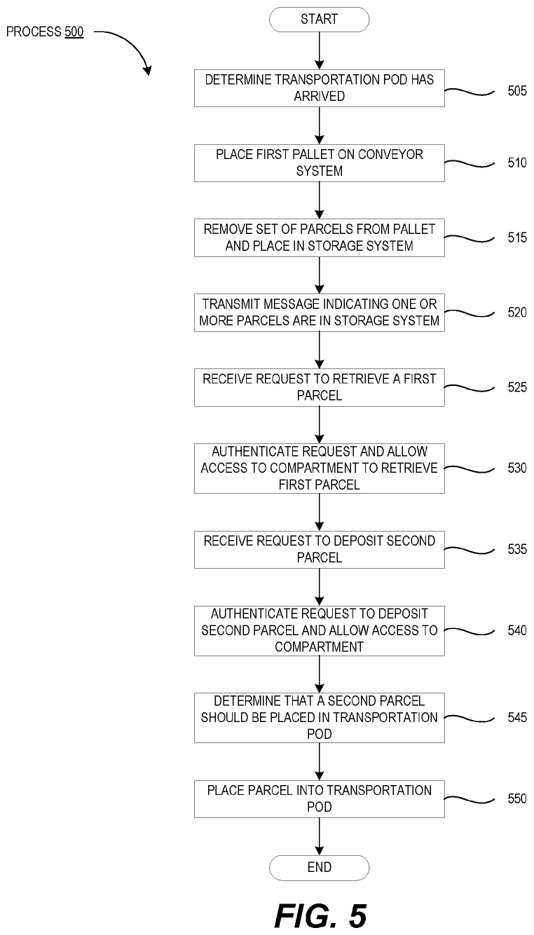

FIG. 5 is a flow diagram of a process 500 of transporting parcels in a transportation system, in accordance with one embodiment of the present disclosure. Process 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the process 500 may be performed by one or more of a payload control system and a computing device.

The process 500 begins at block 505, where the process 500 may determine that a transportation pod has arrived at a destination. For example, the process 500 may receive a message from a control system and/or may detect the transportation pod via one or more sensors (e.g., a camera, a motion sensor, radar, etc.). At block 510 the process 500 remove a first pallet from the transportation pod and may place the first pallet on a conveyor system (e.g., a conveyor belt). Optionally, the first pallet may already be placed on the conveyor system. The process 500 may remove a set of parcels (e.g., one or more parcels) from the first pallet and place the one or more pallets in a storage system (e.g., a locker) at block 515. For example, the set of parcels may be parcels that are to be delivered at the destination. The process 500 may remove the parcels from the first pallet and place them in compartments in the storage system for pick up (e.g., via one or more or a mechanical arm, a lift system, and a conveyor system).

At block 520, the process 500 may optionally transmit a message indicating that one or more parcels are in the storage system. For example, the process 500 may transmit a message (e.g., a chat message, an email, a text message, etc.) to one or more users to indicate that their respective parcels are in compartments in the storage system and are ready for pick up. At block 525, the process 500 may optionally receive a request to retrieve a first parcel. For example, a user may use a control panel, touch screen, keypad, or other interface on the storage system to indicate that the user wants to retrieve a parcel from a compartment of the storage system. At block 530, the process 500 may optionally authenticate the request and allow access to the compartment to retrieve the first parcel. For example, the process 500 may check the username, passcode, password, PIN code, or other credential that was provided by the user and may open a door to the compartment if the passcode, password, PIN code, or other credential is valid.

At block 535, the process 500 may optionally receive a request to deposit a second parcel in the storage system. For example, a user may want to send a parcel to particular a destination (e.g., a warehouse, another station, etc.). The user may request to deposit (e.g., drop off) the parcel for delivery to the particular destination. The process 500 may optionally authenticate the request to deposit the second parcel at block 540. For example, the process 500 may check the username, passcode, password, PIN code, or other credential that was provided by the user to determine whether the user is allowed to deposit a parcel. The process 500 may also optionally allow access to the compartment is the user is authenticated (e.g., open a door to the compartment) to allow the user to deposit the parcel in the compartment at block 540. At block 545, the process 500 may optionally determine that the second parcel should be placed in a transportation pod at the destination. For example, the process 500 may determine that the parcel should be delivered at the particular destination and that the transportation pod will stop at that particular destination. At block 550, the process 500 may optionally place the second parcel into the transportation pod (e.g., via one or more or a mechanical arm, a lift system, and a conveyor system), as discussed above.

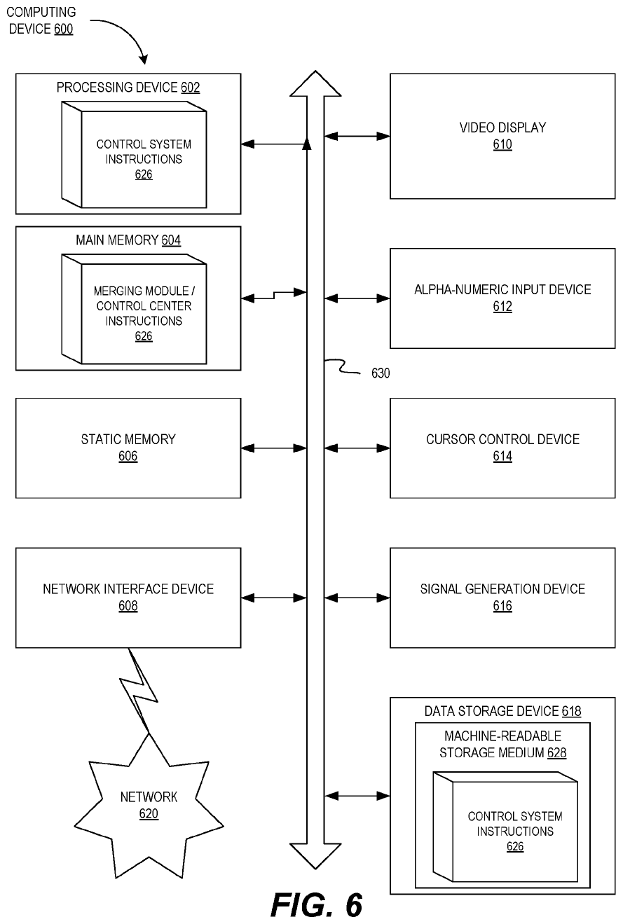

FIG. 6 is a block diagram of an example computing device 600 that may perform one or more of the operations described herein, in accordance with some embodiments. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein. In some embodiments, the computing device 600 may be one or more of an access point and a packet forwarding component.

The example computing device 600 may include a processing device (e.g., a general purpose processor, a PLD, etc.) 602, a main memory 604 (e.g., synchronous dynamic random access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also comprise one or more special-purpose processing devices such as an application specific integrated circuit (ASIC), a field programmable gate array (FPGA), a digital signal processor (DSP), network processor, or the like. The processing device 602 may be configured to execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of instructions, e.g., instructions for carrying out the operations described herein, in accordance with one or more aspects of the present disclosure. Instructions 626 implementing one or more of a payload control system, may also reside, completely or at least partially, within main memory 604 and/or within processing device 602 during execution thereof by computing device 600, main memory 604 and processing device 602 also constituting computer-readable media. The instructions may further be transmitted or received over a network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, various actions, functions, methods, and operations described herein may refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, comprising:
determining that a transportation pod carrying a set of parcels has arrived at a destination, wherein:
the set of parcels are to be delivered to the destination; and
the set of parcels are located on first pallet in the transportation pod;
placing the first pallet on a conveyor system to move the first pallet from the transportation pod to a mechanical arm; and
removing the set of parcels from the first pallet and placing the set of parcels within a storage system via the mechanical arm.

2. The method of claim 1, wherein placing the first pallet on the conveyor system comprises:
changing a height of the first pallet from a first height to a second height, wherein:
the first height is higher or lower than the second height; and
at least a portion of the conveyor system is at the second height; and
moving the first pallet from the transportation pod to the conveyor system.

3. The method of claim 1, wherein removing the set of parcels and placing the set of parcels within the storage system comprises:
determining an identifier for a first parcel of the set of parcels; and
determining a compartment within the storage system based on the identifier for the first parcel;
placing the first parcel within the compartment within the storage system via the mechanical arm.

4. The method of claim 1, further comprising:
transmitting message to a user indicating that a first parcel has been placed in a compartment within the storage system, wherein the message indicates one or more of:
a location of the storage system;
an identifier for the compartment;
a time the first parcel was placed in the compartment.

5. The method of claim 1, further comprising:
receiving a request to retrieve a first parcel from a compartment within the storage system;
authenticating the request retrieve the first parcel from the compartment; and
allowing access to the compartment to allow retrieval of the first parcel from the compartment.

6. The method of claim 1, further comprising:
receiving a request to deposit a first parcel into a compartment within the storage system;
authenticating the request to deposit the first parcel into the compartment; and
allowing access to the compartment to allow placement of the first parcel into the compartment.

7. The method of claim 1, further comprising:
determining whether a first parcel in a compartment of the storage system should be placed in the transportation pod;
in response to determining that the first parcel should be placed in the transportation pod, placing the first parcel in the transportation pod.

8. The method of claim 7, wherein placing the first parcel in the transportation pod comprises:
removing the first parcel from the compartment via the mechanical arm;
placing the first parcel onto a second pallet;
placing the second pallet on the conveyor system, wherein the conveyor system is further to move the second pallet from the mechanical arm to the transportation pod; and
placing the second pallet into the transportation pod via the conveyor system.

9. A system, comprising:
a storage system to store a set of parcels;
a set of pallets, wherein each pallet of the set of pallets is to hold one or more parcels;
a mechanical arm to move the set of parcels from the storage system to the set of pallets;
a conveyor system to move the set of pallets between a transportation pod and the mechanical arm;
a lift system to lift the set of pallets to different heights; and
a control system to control operation of one or more of the storage system, the mechanical arm, the conveyor system; and the lift system.

10. The system of claim 9, wherein the control system is further to:
determine that a transportation pod carrying a set of parcels has arrived at a destination, wherein:
the set of parcels are to be delivered to the destination; and
the set of parcels are located on first pallet in the transportation pod;
place the first pallet on a conveyor system to move the first pallet from the transportation pod to a mechanical arm;
remove the set of parcels from the first pallet and placing the set of parcels within a storage system via the mechanical arm.

11. The system of claim 9, wherein to place the first pallet on the conveyor system the control system is further to:
change a height of the first pallet from a first height to a second height, wherein:
the first height is higher or lower than the second height; and
at least a portion of the conveyor system is at the second height; and
move the first pallet from the transportation pod to the conveyor system.

12. The system of claim 9, wherein to remove the set of parcels and placing the set of parcels within a storage system the control system is further to:
determine an identifier for a first parcel of the set of parcels; and
determine a compartment within the storage system based on the identifier for the first parcel;
place the first parcel within the compartment within the storage system via the mechanical arm.

13. The system of claim 9, wherein the control system is further to:
transmit message to a user indicating that a first parcel has been placed in a compartment within the storage system, wherein the message indicates one or more of:
a location of the storage system;
an identifier for the compartment;
a time the first parcel was placed in the compartment.

14. The system of claim 9, wherein the control system is further to:
receive a request to retrieve a first parcel from a compartment within the storage system;
authenticate the request retrieve the first parcel from the compartment; and
allow access to the compartment to allow retrieval of the first parcel from the compartment.

15. The system of claim 9, wherein the control system is further to:
receive a request to deposit a first parcel into a compartment within the storage system;
authenticate the request to deposit the first parcel into the compartment; and
allow access to the compartment to allow placement of the first parcel into the compartment.

16. The system of claim 9, wherein the control system is further to:
determine whether a first parcel in a compartment of the storage system should be placed in the transportation pod;
in response to determining that the first parcel should be placed in the transportation pod, place the first parcel in the transportation pod.

17. The system of claim 16, wherein to place the first parcel in the transportation pod the control system is further to:
remove the first parcel from the compartment via the mechanical arm;
place the first parcel onto a second pallet;
place the second pallet on the conveyor system, wherein the conveyor system is further to move the second pallet from the mechanical arm to the transportation pod; and
place the second pallet into the transportation pod via the conveyor system.

18. A non-transitory computer readable medium having instructions stored thereon that, when executed by a processing device, cause the processing device to:
determine that a transportation pod carrying a set of parcels has arrived at a destination, wherein:
the set of parcels are to be delivered to the destination; and
the set of parcels are located on first pallet in the transportation pod;
place the first pallet on a conveyor system to move the first pallet from the transportation pod to a mechanical arm; and
remove the set of parcels from the first pallet and placing the set of parcels within a storage system via the mechanical arm.

19. The non-transitory computer readable medium of claim 18, wherein the instructions further cause the processing device to:
transmitting message to a user indicating that a first parcel has been placed in a compartment within the storage system, wherein the message indicates one or more of:
a location of the storage system;
an identifier for the compartment;
a time the first parcel was placed in the compartment.

20. The non-transitory computer readable medium of claim 18, wherein the instructions further cause the processing device to:
receiving a request to retrieve a first parcel from a compartment within the storage system;
authenticating the request retrieve the first parcel from the compartment; and
allowing access to the compartment to allow retrieval of the first parcel from the compartment.
